(19) United States
(12) Patent Application Publication
(10) Pub. No.: US 2009/0102350 A1
(43) Pub. Date: Apr. 23, 2009

(54) FIELD EMITTER SPACER CHARGE DETRAPPING THROUGH PHOTON EXCITATION

(75) Inventor: Hao Li, Chandler, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/874,364

(22) Filed: Oct. 18, 2007

(51) Int. Cl. H01J 1/62; H01J 9/236

(52) U.S. Cl. 313/496; 445/6

(57) ABSTRACT

A method and apparatus for neutralizing the charge on a spacer (22, 38) positioned between an anode (12) and a cathode plate (24) within a flat panel display includes emitting electrons from the cathode plate (24) toward the anode (12), and applying electromagnetic radiation to the spacer (22, 38) to neutralize the charge caused by electrons striking the spacer (22, 38). The electromagnetic radiation may be emitted from a source such as a light emitting diode (34), or a phosphor layer (54) or region (62) on the anode (12).

### FIELD

The present invention generally relates to field emitter devices and more particularly to a method and apparatus for neutralizing a charge on spacers of field emitter devices.

### BACKGROUND

Field emission displays are well known in the art. A field emission display includes an anode plate and a cathode plate that define a thin envelope. Typically, the anode plate and cathode plate are thin enough to necessitate some form of a spacer structure to prevent implosion of the device due to the pressure differential between the internal vacuum and external atmospheric pressure. The spacers are disposed within the active area of the device, which includes the electron emitters and phosphors.

The potential difference between the anode plate and the cathode plate is typically within a range of 300-10,000 volts. To withstand the potential difference between the anode plate and the cathode plate, the spacers typically include a dielectric material. Thus, the spacers have dielectric surfaces that are exposed to the evacuated interior of the device.

During the operation of the field emission display, electrons are emitted from the electron emitters, such as Spindt tips or carbon nanotubes, toward the anode plate. These electrons traverse the evacuated region and impinge upon phosphors positioned on the anode plate; however, some of these electrons may strike the dielectric surfaces of the spacers. In this manner, the dielectric surfaces of the spacers become charged. Typically, the dielectric spacers become positively charged because the secondary electron yield of the spacer material is initially greater than one.

Numerous problems arise due to the charging of the dielectric surfaces within a field emission display. For example, control over the trajectory of electrons adjacent to the spacers is lost. Also, the risk of electrical arcing events increases dramatically.

Two known approaches for reducing the charge on dielectric surfaces such as the spacers are surface conduction and anode discharge. However, for the surface conduction method requires a very low surface conductivity which requires exotic conduction mechanisms that are usually field sensitive and lifetime is a major issue with thermal and electron assisted decomposition.

It is known to use electron current from the electron emitters coupled with a fixed resistance connected between the anode plate and an anode voltage source to reduce the voltage at the anode plate and cause the electrons to be attracted by the charged surfaces instead of the anode. The electrons are used to neutralize the charged surfaces. However, the electrons that bounce off of or emit secondarily from the dielectric surface also strike the phosphors, which results in a visible “flash” of light being generated at the viewing screen of the field emission display. Furthermore, the fixed resistance between the anode plate and the anode voltage source necessitates a high current to pull down the anode voltage, which results in large power losses. Conventionally, this discharge is accomplished every frame, resulting in a high current drain and a perceptive “hum”.

It is also known to use an anode discharge process to neutralize spacer surface charges. This is done by running the display in a discharge mode once every frame or several frames. To achieve the discharge mode of operation, the anode voltage is reduced to a lower voltage, which may be several hundred volts or as low as ground potential. When the anode voltage is lowered, the gate/row voltage is turned high to extract electrons from the emitters. These electrons are attracted by the positive surface charging on the spacer surface and they neutralize the positively charged spacers by “adding” electrons to the spacer.

Accordingly, there exists a need for a method for reducing charge accumulation in a field emission display, which reduces or eliminates this visible “flash” and which reduces the power loss associated with pulling down the anode voltage. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a partial isometric view of an anode of a field emitter device in accordance with an exemplary embodiment;

FIG. 2 is a partial cross section taken along the lines 2-2 of FIG. 1;

FIG. 3 is a cross section of a light source emitting light through a spacer in accordance with the embodiment of FIGS. 1 and 2;

FIG. 4 is a partial cross section of another exemplary embodiment;

FIG. 5 is a partial cross section of yet another exemplary embodiment; and

FIG. 6 is a partial cross section of still another exemplary embodiment.

### DETAILED DESCRIPTION

Electromagnetic radiation, including light in the visible spectrum, but preferably ultraviolet (UV) radiation, is applied against a dielectric surface (insulator surface), such as the outer surface of spacers, of field emission devices to neutralize the charge on the dielectric surface. In another exemplary embodiment, the radiation is directed into the spacer, which acts as a light guide. As the radiation repeatedly reflects off the inner surface of the spacer (light guide), the charges on the surface are mobilized and subsequently neutralized. In both exemplary embodiments, charges trapped inside the band gap of the dielectric surface are excited by the high energy photons.

Field emission displays can modulate light with sub-millisecond response times, and they are also comparatively inexpensive light sources. This makes them desirable for both active visual displays and backlight applications. An FED includes an anode, a cathode, and spacers that keep the anode and the cathode from collapsing under vacuum. Electrons emitted from the cathode strike cathodoluminescent phosphors on the anode to produce light. The efficiency of cathodoluminescent phosphors increases sharply with electron energy and anode voltage. For energy efficient displays/backlights, anode voltages exceeding 5 KV are required. Moreover, cathodoluminescent light sources are known to age as a function of the overall number of electrons hitting the phosphor. Achieving brightness with a high current and low anode voltage limits the lifetime of the phosphors, and correspondingly, of the display/backlight. For the lifetime issue, it is desirable to operate at high voltages (5-15 KV) and low currents. This is especially true for a backlight because it must produce 20 times more light than the phosphors of a CRT display due to the inefficient optical shutters like LCDs. This can be accomplished by using a higher duty cycle, which is feasible because the number of scan lines in an FED backlight is much smaller than in traditional field emission displays.

It is well known that under electron bombardment, spacers may charge up due to secondary electron emission from the spacer surface. Charged spacers significantly alter the local electric field and consequently alter the trajectories of the electrons around the spacer, resulting in “visible” spacers. In more serious cases, this charging leads to arcing and device destruction. The spacer technology for a typical field emission display holding off these voltages is difficult to implement, and would involve very leaky spacers and reliability problems (see U.S. Pat. No. 5,985,067), or extra discharging electronics (see U.S. Pat. No. 6,031,336).

The following detailed description is merely exemplary in nature and is not intended to limit the invention or the application and uses of the invention. Furthermore, there is no intention to be bound by any theory presented in the preceding background or the following detailed description.

The exemplary embodiments described herein may be fabricated using known lithographic processes as follows. The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

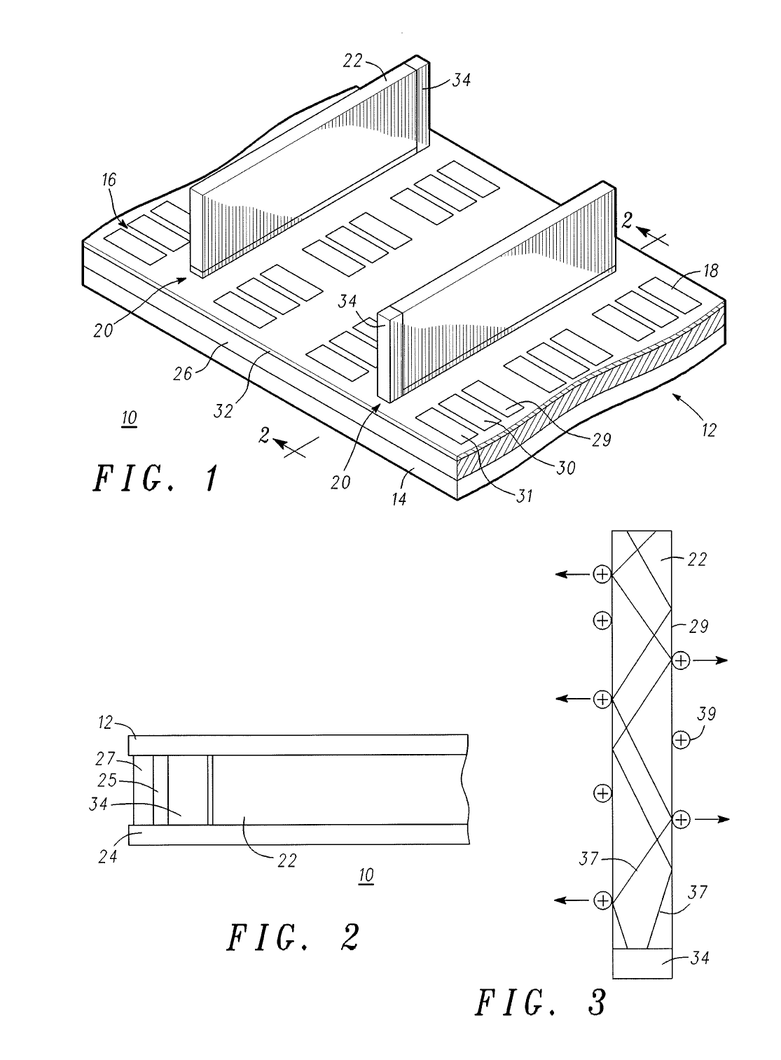

Referring to FIG. 1 of a partial cutaway isometric view, and to FIG. 2 of a partial cross sectional view taken through one of the spacers 22 from line 2-2, a display 10 shows a first display plate 12, e.g., an anode, for a field emission display that includes a transparent plate 14, which is typically made of glass. A plurality of pixels 16 arranged typically in rows and columns across the anode 12 include deposits of a light emitting material 18, such as a cathodoluminescent material, or phosphor. A plurality of regions 20 exist between the rows and/or columns for making physical contact with spacers 22 so that a predetermined spacing can be maintained between the anode 12 and a second display plate 24 (FIG. 2), e.g., a cathode, without interfering with the light emitting function of the display 10 and thereby defining an evacuation area 25 maintained by vacuum seal 27. The spacers 22 comprise a rigid material transparent to visible and/or UV light, e.g., SiO₂ or Al₂O₃, and are able to withstand intense pressure exerted by the anode and cathodes.

A black surround layer (black matrix) 26, for example ruthenium oxide, is formed on the transparent plate 14. The black surround layer 26 may comprise a thickness in the range of 1-20 μm, and more preferably is 5 μm. In the preferred embodiment, the layer 26 is deposited with thick film techniques such as screen printing, electrophoretic deposition, or electroplating rather than thin film vacuum deposition techniques. This layer may be formed across the transparent plate 14 and then screen printed to form the regions 20. For anodes built with the Fodel (photo definable screen print paste) technology, the silver fodel and the black matrix can be deposited in sequential steps and then exposed with the same photomask. The light emitting material 18 is placed in the pixels 16 by screen printing.

The phosphor-coated display anode 12 described above presents the light emitting material to the direct impact of electrons. This configuration is desirable for displays which use a low anode voltage, e.g., less than 4 kilovolts. High voltage display designs benefit from providing a thin aluminum layer 32 over the light emitting material. The thin layer 32 of aluminum is formed on the light-emitting layer 18 by physical vapor deposition techniques such as evaporation or sputtering. The aluminum layer 32 acts as a reflector and directs all the light generated through the faceplate to the viewer. Without this reflection, half of the light goes back towards the electron emitters (not shown) within the second display plate 24. Effectively, the light output from the display anode 12 (faceplate) doubles with the use of the aluminum layer. However, the aluminum layer acts to absorb the energy of the electrons, thereby reducing the light emitted from the faceplate. When using a very thin aluminum layer, nominally 50 nanometers thick, the benefits of reflection outweigh the detriments of energy absorption mentioned above in the range of 4000 volts. The aluminum layer 32 may comprise a thickness in the range of 10-1000 nm, and more preferably is 50 nm.

In accordance with one exemplary embodiment, still referring to FIGS. 1 and 2, a light source 34, e.g., an light emitting diode, is disposed on the layer 32 and contiguous to the spacers 22 and is preferably adjacent the spacer 22. Though it is preferable to have the light source 34 disposed on alternating ends of the spacers 22, they may be disposed in other arrangements, e.g., on the same end. The spacer 22 is a transparent material so light emitted from the light source 34 passes into and is transmitted through the spacer 22 in a manner that light 37 travels through a light guide (FIG. 3). When the light 37 strikes the surface 29 of the spacer 22 that is near a charge 39, the field accompanying the light (photon) causes the charge 39 to be detrapped from the bandgap on the surface 37.

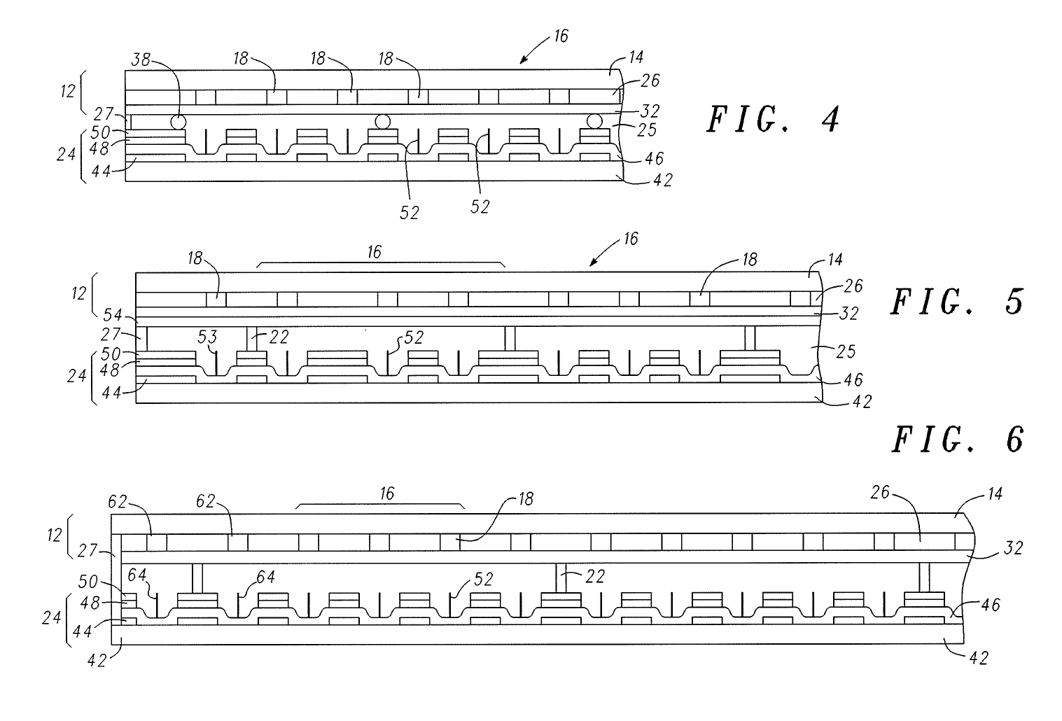

Though the spacers 22 shown in FIGS. 1 and 2 are in a typical configuration of a rectangle block, other configurations are envisioned. For example, FIG. 4 illustrates a spacer as an optical fiber 38 having a tubular shape. Similar elements appearing in the various exemplary embodiments will be represented by the same reference numeral. The optical fiber 38 must be rigid enough to maintain the proper distance between the anode 12 and the second display plate 24. FIG. 4 shows the second display plate 24 (cathode plate), including a substrate 42, a cathode metal layer 44, a resistive ballast layer 46, a dielectric layer 48, a gate metal layer 50, and emitters 52. The emitters 52 may comprise any type of electron emitter, such as Spindt tip and carbon nanotubes. Though a single carbon nanotube 52 is shown, a plurality of carbon nanotubes for each carbon nanotube 52 shown would be typical. It is also possible to have several spacers share one common LED UV emitter. In this configuration, the light fibers are bent accordingly to reach the shared light source. Alternatively, additional light guides can also be used to guide light to the ends of straight spacers.

A third exemplary embodiment shown in FIG. 5 includes a layer 54 of cathodoluminescent material disposed on the aluminum layer 32. The material in layer 54 emits photons, preferably in the ultraviolet range of wavelengths which impact the dielectric material of, for example, the spacer 22. The electrons from the emitters excite photons in the layer 54, but continue through the layer 54 to also strike the cathodoluminescent material 18. Note that some electron emitters 53 may be positioned near the spacer 22 for causing photons to be emitted from the layer 54 without being associated with a pixel 16. It should be noted that in this embodiment, the spacers are not necessarily transparent.

Yet another exemplary embodiment is shown in FIG. 6 and includes pixels 16 as in the previous exemplary embodiment having three phosphors 18 disposed within the black matrix material 26 and having electron emitters 52 associated with each of the phosphors 18. A metal layer 32 is disposed covering the black matrix material 26 and the phosphors 18. Additional phosphors 62, disposed within the black matrix material 26 and preferably near the dielectric material (spacers 22), have additional electron emitters 64 associated therewith. The phosphors 62 contain a material that emits photons, preferably in the ultraviolet spectrum for neutralizing the charge on the spacers 22, when impacted by electrons from the electron emitters 64. It should be noted that in this embodiment the spacers are not necessarily transparent.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of neutralizing the charge on a spacer positioned between an anode and a cathode plate within a field emitter device, comprising:
emitting electrons from the cathode plate toward the anode; and
applying electromagnetic radiation to the spacer to neutralize the charge caused by electrons striking the spacer.

2. The method of claim 1 wherein the applying step comprises emitting the electromagnetic radiation from a light emitting diode positioned contiguous to the spacer.

3. The method of claim 1 wherein the applying step comprises emitting the electromagnetic radiation from a phosphor layer disposed on the anode, in response to the electrons impacting thereon.

4. The method of claim 1 wherein the applying step comprises emitting the electromagnetic radiation from a phosphor region disposed on the anode in response to a portion of the electrons.

5. The method of claim 1 wherein the applying step comprises transmitting the electromagnetic radiation within the spacer.

6. The method of claim 1 wherein the applying step comprises transmitting the electromagnetic radiation within an optical fiber.

7. A field emitter device comprising:
an anode;
a cathode plate;
a plurality of spacers disposed between the anode and cathode plate; and
an apparatus disposed to apply electromagnetic radiation to the plurality of spacers.

8. The field emitter device of claim 7 wherein the plurality of spacers are transparent, the electromagnetic radiation being transmitted within each of the plurality of spacers.

9. The field emitter device of claim 8 wherein each of the plurality of spacers comprise an optical fiber.

10. The field emitter device of claim 7 wherein each of the plurality of spacers comprise an opaque structure having an outer surface, the electromagnetic radiation being applied to the outer surface.

11. The field emitter device of claim 7 wherein the apparatus comprises a light emitting diode disposed contiguous to each of the plurality of spacers.

12. The field emitter device of claim 7 wherein the apparatus comprises a phosphor layer disposed on the anode.

13. The field emitter device of claim 7 wherein the apparatus comprises a phosphor region disposed on the anode and a unique emitter associated therewith disposed on the cathode plate.

14. A field emitter device comprising:
a first display plate having an inner surface;
a second display plate having an inner surface spaced apart from the inner surface of the first display plate;
a plurality of spacers disposed between the inner surfaces of the first and second display plate;
a thick film black matrix material patterned on the inner surface of the first display plate to define a plurality of pixels;
a cathodoluminescent material formed within each of the plurality of pixels;
an aluminum layer disposed on the thick film black matrix material and the cathodoluminescent material;
a plurality of emitters disposed on the inner surface of the second display plate and capable of emitting electrons at the cathodoluminescent material; and
at least one electromagnetic radiation emitting devices, each disposed to apply radiation to at least one of the plurality of spacers.

15. The field emitter device of claim 14 wherein the plurality of spacers are transparent, and the plurality of electromagnetic radiation emitting devices configured to transmit the electromagnetic radiation within each of the plurality of spacers.

16. The field emitter device of claim 15 wherein each of the plurality of spacers comprise an optical fiber.

17. The field emitter device of claim 14 wherein each of the plurality of spacers comprise an outer surface for receiving the electromagnetic radiation.

18. The field emitter device of claim 14 wherein the device comprises a light emitting diode disposed contiguous to each of the plurality of spacers.

19. The field emitter device of claim 14 wherein the electromagnetic radiation emitting devices comprises a phosphor layer disposed on the anode.

20. The field emitter device of claim 14 wherein the device comprises a phosphor region disposed on the anode and a unique emitter associated therewith disposed on the cathode plate.
